(19) United States
(12) Patent Application Publication
(10) Pub. No.: US 2015/0188341 A1
(43) Pub. Date: Jul. 2, 2015

(54) MOBILE POWER SOURCE WITH KEYBOARD

(71) Applicants: HONG FU JIN PRECISION INDUSTRY (ShenZhen) CO.,LTD., Shenzhen (CN); HON HAI PRECISION INDUSTRY CO., LTD., New Taipei (TW)

(72) Inventor: GUANG-FENG OU, Shenzhen (CN)

(21) Appl. No.: 14/540,505

(22) Filed: Nov. 13, 2014

(30) Foreign Application Priority Data
Dec. 31, 2013 (CN) 201310747928.1

(51) Int. Cl. H02J 7/00

(52) U.S. Cl. CPC H02J 7/0042; H02J 7/0052; H02J 7/0047; H02J 2007/005

(57) ABSTRACT

A mobile power source with keyboard includes a power source body configured to charge an electronic device and a keyboard mounted to the power source body. A cover is rotatably mounted to the power source body. The cover is exposed out of the keyboard when rotating open, thus the keyboard can input instruction to the electronic device. The cover covers the keyboard to protect the keyboard when rotating to be closed.

### CROSS-REFERENCE TO RELATED APPLICATIONS

This application claims priority to Chinese Patent Application No. 201310747928.1 Dec. 31, 2013, the contents of which are incorporated by reference herein.

### FIELD

The subject matter herein generally relates to a mobile power source.

### BACKGROUND

A mobile power source with a keyboard is used to charge an electronic device.

### BRIEF DESCRIPTION OF THE DRAWINGS

Implementations of the present technology will now be described, by way of example only, with reference to the attached figures.

FIG. 1 is an exploded, isometric view of an embodiment of a mobile power source with a keyboard.

FIG. 2 is an assembled view of the mobile power source of FIG. 1, and a cover is closed.

FIG. 3 is similar to FIG. 2, but the cover is open.

FIG. 4 is similar to FIG. 3, but viewed from different angle.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, components have not been described in detail so as not to obscure the related relevant feature being described. Also, the description is not to be considered as limiting the scope of the embodiments described herein. The drawings are not necessarily to scale and the proportions of certain parts have been exaggerated to better illustrate details and features of the present disclosure.

Several definitions that apply throughout this disclosure will now be presented.

The term “inside” indicates that at least a portion of a region is partially contained within a boundary formed by the object. The term “coupled” is defined as connected, whether directly or indirectly through intervening components, and is not necessarily limited to physical connections. The connection can be such that the objects are permanently connected or releasably connected. The term “substantially” is defined to be essentially conforming to the particular dimension, shape, or other feature that the term modifies, such that the component need not be exact. For example, substantially cylindrical means that the object resembles a cylinder, but can have one or more deviations from a true cylinder. The term “comprising,” when utilized, means “comprising, but not necessarily limited to”; it specifically indicates open-ended inclusion or membership in the so-described combination, group, series and the like.

The present disclosure is described in relation to a mobile power source with a keyboard configured to charge and input instruction to an electronic device.

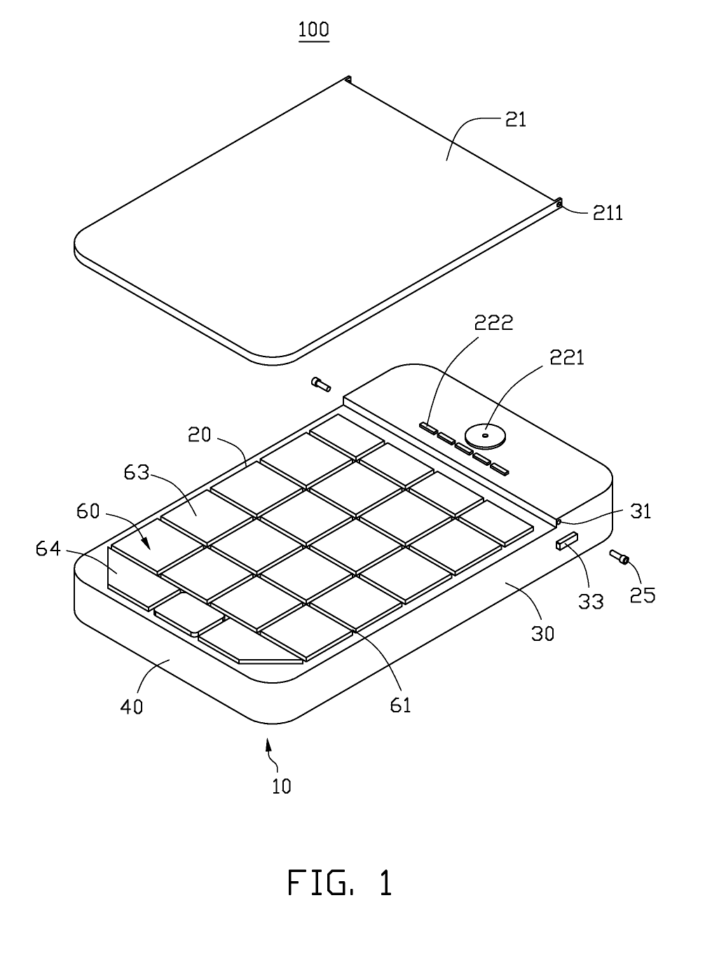

FIG. 1 illustrates an embodiment of a mobile power source 100. The mobile power source 100 comprises a power source body 10 and a keyboard 60 mounted on the power source body 10. The mobile power source 100 is configured to charge and input instruction to an electronic device (not shown).

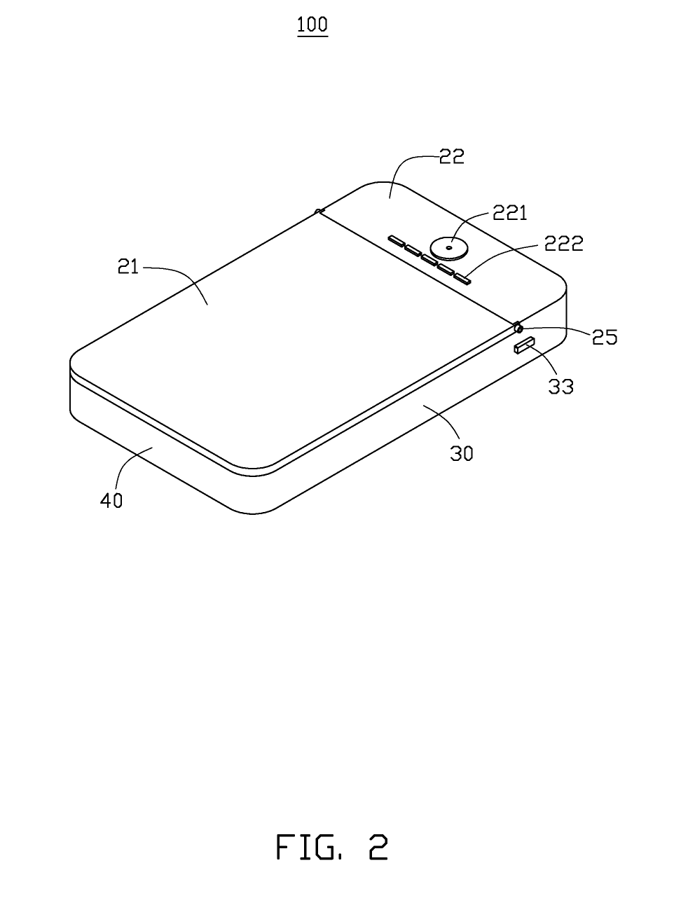

FIG. 2 illustrates that the power source body 10 comprises a top wall 20, two first sidewalls 30, and two second sidewalls 40. The top wall 20 is rotatably mounted to a cover 21. The top wall 20 is provided with a display portion 22. The first sidewalls 30 and second sidewalls 40 are substantially perpendicular to the display portion 22. A through hole 211 is defined in each of two ends of the cover 21. A mounting hole 31 is defined in each of the two second sidewalls 30. A first instructor light 221 is mounted on the display portion 22. In one embodiment, the first instructor light 221 can be green or red; the mobile power source 100 is charged fully when the first instructor light 221 is green; the mobile power source 100 is not charged fully when the first instructor light 221 is red. A plurality of second instructor lights 222 are mounted on the display portion 22. The second instructor lights 222 can be lit or unlit. Different quantities of the lit second instructor lights 222 mean different electric quantities of the mobile power source 100.

One of the two first sidewalls 30 is provided with a first switch 32. The mobile power source 100 can charge the electric device and input instruction to the electric device when the first switch 32 is turned on. The mobile power source 100 can only charge the electric device when the first switch 32 is turned off.

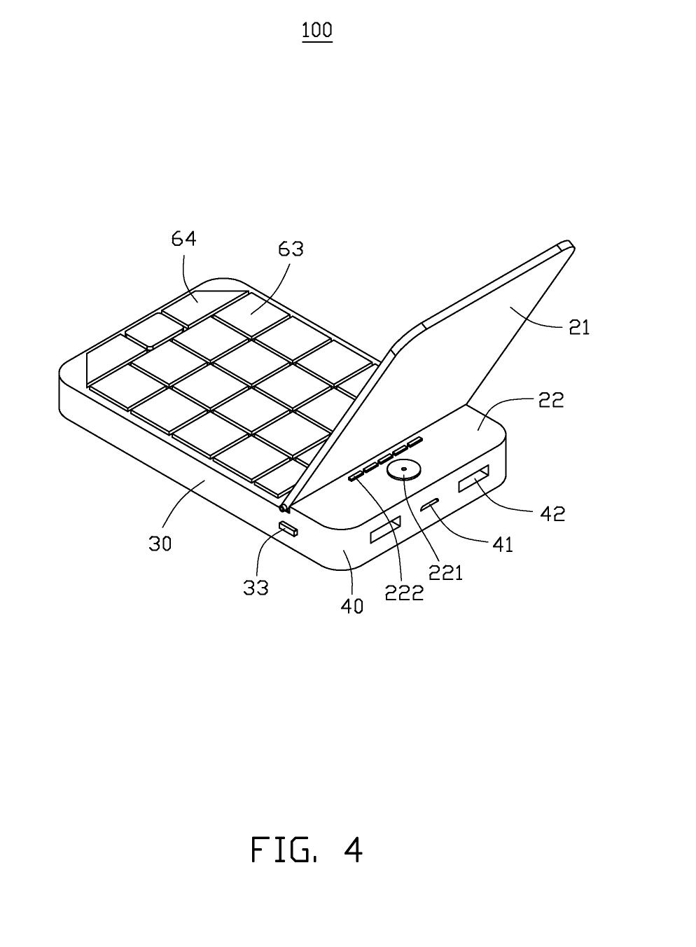

FIG. 4 illustrates that one of the two second sidewalls 40 defines a first hole 41 and two second holes 42. A cable (not shown) is configured to insert into the first hole 41 to connect to a power source (not shown), thus the power source can charge the mobile power source 100. The cable is also configured to be inserted into the second hole 42 to connect to the electric device, thus the mobile power source 100 can charge the electric device.

In the embodiment, the keyboard 60 is a BLUETOOTH® keyboard. The keyboard 60 comprises a motherboard 61 mounted on the top wall 20 and a BLUETOOTH® chip (not shown). The motherboard 61 comprises a key unit (not labeled). The key unit comprises a plurality of main keys 63 and a plurality of auxiliary keys 64. A second switch 33 is provided on the other first sidewall 30. The main keys 63 can input different instruction with the second switch 33 and the auxiliary keys 64. The BLUETOOTH® chip can connect to the electronic device to enable the keyboard 60 to input instruction to the electronic device.

FIG. 1 illustrates when in assembly, the keyboard 60 is mounted to the power source body 10. The cover 21 is placed on the power source body 10. The through holes 211 are aligned with the corresponding mounting holes 31. The fastening members 25 are mounted in the through holes 211 and the corresponding mounting holes 31. The cover 21 is rotatably mounted to the power source body 10. The cover 21 is rotated to a closed position to cover the keyboard 60.

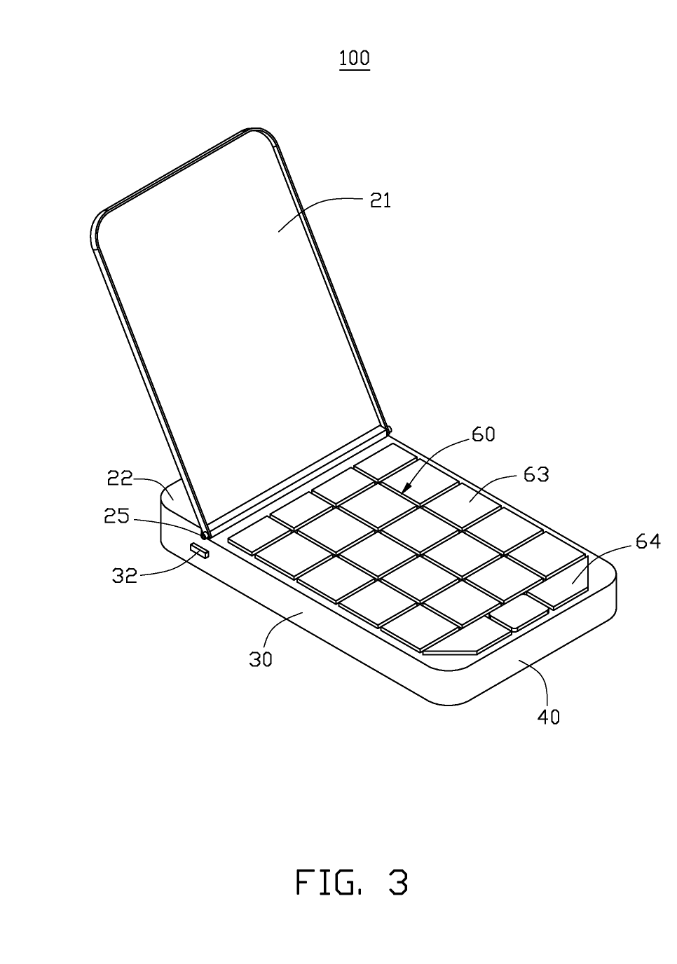

FIGS. 2, 3, and 4 illustrate that when charging the mobile power source 100, the cover 21 is rotated to the closed position. One end of the cable is inserted into one of the second holes 42. The first instructor light 221 is red when the mobile power source 100 is not charged fully. If the first instructor light 221 is green, it shows that the mobile power source 100 is charged fully.

When the mobile power source 100 is charging the electronic device, one end of the cable is inserted into the one of the second holes 42 and the other end of the cable is coupled to the electronic device. The second instructor light 222 is lit. Different numbers of lit second instructor lights 222 means a different electric power of the mobile power source 100, and the less number of lit second instructor lights 222 means the less electric power of the mobile power source 100. There is no electricity of the mobile power source 100 when no second instructor lights 222 are lit. When the electronic device needs to be charged and needs instruction, one end of the cable is inserted into one of the second holes 42 and the other end of the cable is coupled to the electronic device. The cover 21 is rotated open. The first switch 32 is turned on, starting the BLUETOOTH® chip. The BLUETOOTH® chip is coupled to the electronic device. The main keys 63 can be used to input different instruction with the second switch 33 and the auxiliary keys 64.

It is to be understood that even though numerous characteristics and advantages have been set forth in the foregoing description of embodiments, together with details of the structures and functions of the embodiments, the disclosure is illustrative only and changes may be made in detail, especially in the matters of shape, size, and arrangement of parts within the principles of the disclosure to the full extent indicated by the broad general meaning of the terms in which the appended claims are expressed.

What is claimed is:

1. A mobile power source with keyboard comprising:
a power source body configured to charge an electronic device; and
a keyboard mounted to the power source body;
wherein, a cover is rotatably mounted to the power source body;
the keyboard exposes out of the cover when the cover rotates to a first position;
the cover covers the keyboard when rotating to a second position; and
the second position is different from the first position.

2. The mobile power source of claim 1, wherein the cover defines a through hole, the power source body defines a mounting hole, and a fastening member is mounted in the through hole and the mounting hole to enable the cover to be rotatably mounted to the power source body.

3. The mobile power source of claim 1, wherein the keyboard comprises a motherboard mounted on the power source body, and a BLUETOOTH® chip for coupling to the electronic device is mounted in the inside of the motherboard.

4. The mobile power source of claim 3, wherein the motherboard is provided with a key unit, and the key unit is configured to input different instructions to the electronic device.

5. The mobile power source of claim 3, wherein the power source body comprises a first sidewall, the sidewall is provided with a first switch for turning on the BLUETOOTH® chip.

6. The mobile power source of claim 5, wherein the motherboard is provided with a key, the first sidewall is provided with a second switch, and the second switch can input instruction to the electronic device together with the key.

7. The mobile power source of claim 1, wherein the power source body comprises a second sidewall, the second sidewall defines a first hole, and a cable can inserting into the first hole to charge the mobile power source.

8. The mobile power source of claim 7, wherein the second sidewall defines a second hole, a cable can insert into the second hole to charge the electronic device.

9. The mobile power source of claim 1, wherein the power source comprises a display portion, the display portion is provided with a first instructor light, the first instructor light can be different colors, and the different colors mean the mobile power source is whether charged fully.

10. The mobile power source of claim 9, wherein the display portion is provided with a plurality of second instructor lights, the second instructor lights can be lit or unlit, and different quantity of the light second instructor lights mean different electric quantity of the mobile power source.

11. A mobile power source with keyboard comprising:
a power source body configured to charge an electronic device; and
a keyboard is mounted to the power source body;
wherein, a cover is rotatably mounted to the power source body;
the keyboard exposes out of the cover to be operated to input instruction to the electronic device when the cover rotates open; and
the cover covers the keyboard to protect the keyboard when rotating to be closed.

12. The mobile power source of claim 11, wherein the cover defines a through hole, the power source body defines two mounting holes, and two fastening member is mounted in the through hole and the mounting holes to enable the cover to be rotatably mounted to the power source body.

13. The mobile power source of claim 11, wherein the keyboard comprises a motherboard mounted on the power source body, and a BLUETOOTH® chip for coupling to the electronic device is mounted in the inside of the motherboard.

14. The mobile power source of claim 13, wherein the motherboard is provided with a key unit, and the key unit is configured to input different instructions to the electronic device.

15. The mobile power source of claim 13, wherein the power source body comprises a first sidewall, the sidewall is provided with a first switch for turning on the BLUETOOTH® chip.

16. The mobile power source of claim 15, wherein the motherboard is provided with a key, the first sidewall is provided with a second switch, and the second switch can input instruction to the electronic device together with the key.

17. The mobile power source of claim 11, wherein the power source body comprises a second sidewall, the second sidewall defines a first hole, and a cable can insert into the first hole to charge the mobile power source.

18. The mobile power source of claim 17, wherein the second sidewall defines a plurality second holes, each cable can inserting into each second hole to charge one electronic device.

19. The mobile power source of claim 11, wherein the power source comprises a display portion, the display portion is provided with a first instructor light, the first instructor light can be different colors, and the different colors means the mobile power source is whether charged fully.

20. The mobile power source of claim 19, wherein the display portion is provided with a plurality of second instructor lights, the second instructor lights can be lit or unlit, and different quantity of the light second instructor lights mean different electric quantity of the mobile power source, and the less light second instructor lights mean the less electric quantity of the mobile power source.
